(19) United States
(12) Patent Application Publication
(10) Pub. No.: US 2018/0288590 A1
(43) Pub. Date: Oct. 4, 2018

(54) EXPOSING SERVICES USING NETWORK INTERFACES

(71) Applicant: ZTE Corporation, Shenzhen, Guangdong (CN)

(72) Inventor: Rajesh Bhalla, Gahanna, OH (US)

(21) Appl. No.: 15/770,163

(22) PCT Filed: Oct. 20, 2016
(86) PCT No.: PCT/US2016/057966

§ 371 Date: Apr. 20, 2018

Related U.S. Application Data
(60) Provisional application No. 62/244,067, filed on Oct. 20, 2015.

(51) Int. Cl. H04W 4/70; H04L 29/08

(52) U.S. Cl. CPC H04W 4/70; H04W 88/14; H04L 67/2823

(57) ABSTRACT

A service exposure function located in a trusted domain of two different communication networks provides interfaces to an application server in a first network in order to make available resource information from the second network to the application server to facilitate machine to machine communication between an application executed on the application server and a communication device operating in a second network.

### CROSS-REFERENCE TO RELATED APPLICATIONS

This patent document claims the benefit of priority of U.S. Provisional Patent Application No. 62/244,067, filed on Oct. 20, 2015. The entire content of the before-mentioned patent application is incorporated by reference as part of the disclosure of this application.

### BACKGROUND

This document relates to machine-to-machine (M2M) communication.

M2M communication generally refers to communication between two different devices, which is not explicitly triggered by a user. Devices may perform M2M communication using wired or wireless connectivity. The communication is typically initiated by an application residing on one of the machine to gather or send information to a counterpart application on the other machine.

### SUMMARY

This document describes technologies, among other things, for enabling deployment of machine to machine application over communication networks that differ from each other in a variety of ways such as the frequency band and communication protocols.

In one aspect, methods, systems and apparatus for facilitating interoperation of a first application entity operating in a first communication network and a second application entity operating in a second communication network are disclosed. The technique includes operating, in a trusted domain of the first communication network and the second communication network, a service capability exposure function (SCEF) comprising a storage by which service capability information for at least some application entities in the first communication network and/or the second communication network is made accessible, communicating, by the SCEF, using a first pre-defined protocol via a first interface of the SCEF, with a network entity in the first communication network to obtain information about service resources available in the first communication network, and communicating, by the SCEF, using a second pre-defined protocol via a second interface of the SCEF, with an application entity operating in the second network to provide the application entity with the information about the service resources available in the first communication network.

These and other aspects, and their implementations and variations are set forth in the drawings, the description and the claims.

### BRIEF DESCRIPTION OF THE DRAWINGS

FIG. 1 depicts example wireless network architecture.

FIG. 2 is a block diagram of a radio device operable in a wireless network.

FIG. 3 shows an example of a method of facilitating M2M communication.

FIG. 4 shows an example block diagram of an apparatus for facilitating M2M communication.

FIG. 5 shows an example of functional architecture of an oneM2M system.

FIG. 6 shows an example of an M2M service delivery platform protocol stack.

FIG. 7 shows an example M2M system configuration.

FIG. 8 shows an example of 3GPP architecture for service capability exposure.

FIG. 9 shows an example embodiment in which a oneM2M platform hosts SCEF.

FIG. 10 shows an example embodiment in which SCEF is an independent functional entity.

FIG. 11 shows an example embodiment in which a oneM2M implementation supports other APIs.

FIG. 12 is an example illustration of an interworking architecture in the context of oneM2M communication.

Like reference symbols in the various drawings indicate like elements.

### DETAILED DESCRIPTION

In Machine to Machine (M2M) communications, the two endpoints between which communication occurs often are in different networks. For example, one device may be in a cellular network, e.g., a 3GPP or Long Term Evolution (LTE) network, or a wireless local area (WLAN) network such as 802.11, while the other device may be in the Internet cloud. In a typical application scenario, one endpoint may be a sensor or a utility box that may go offline for extended time periods and another endpoint may be an application server such as a utility billing server or an M2M server that may be deployed in a managed network.

When M2M devices sleep for long durations and awaken intermittently, these devices may be operating and communicating in a network that looks, resource-wise, different from the last time the M2M device was awake. Resources may include physical layer bandwidth, application level support, power control, etc.

The success of M2M services, e.g., efforts to write (e.g., software coding), develop, deploy and operate M2M services should not depend on such operational variability in M2M communication. Changes to available resources at run time may be even more critical for M2M communication especially because M2M devices may not be accessible via a user interface for changing their settings or downloading new apps to the user device to keep up with changes to the operational conditions.

There has been work in standardization organizations such as 3GPP, ETSI TC M2M and oneM2M that enables 3rd parties to interact with Underlying Networks for accessing services. These standards organizations have been working under the assumption that M2M related services can be offered by the Underlying Network operators, and that such services can be accessed by the 3rd parties that have business agreements with the underlying network operators. The services can be accessed by using capabilities beyond pure IP based transmission, such as by the use of APIs.

Similarly, for devices that support a variety of applications such as smartphones, it has been a challenge for the network operators to develop new business models that facilitate deployment and QoE enhancements for the diverse types of services needed by such applications. Agreements with the underlying network operators for exposing certain network services can help application service providers ease the challenge. Some private deployments have allowed operators to provide to application providers some services (e.g. statistics, location). To avoid time consuming and costly adaptations in multi-vendor environments, there have been efforts in 3GPP to standardize the types of services that can be exposed by the 3GPP network for use by 3rd parties in a trusted environment. 3GPP SA2 working group recently did some work on Machine Type Communications (MTC) features that allows an application to take advantage of the service capabilities provided by the 3GPP system. In general, such service capability exposure features are not limited to MTC applications and can be used by other applications such as by smartphone applications as well.

Specifically, for Release 13, 3GPP SA2 has progressed the Stage 2 architecture work on topics such as AESE (Architecture Enhancements for Service Capability Exposure), MONTE (Monitoring Enhancements), GROUPE (Group based Enhancements) and HLCom (Optimizations to support high latency communications). As part of this work, 3GPP SA2 defined an entity viz. Service Capability Exposure Function (SCEF) that provides a means to expose the services and capabilities provided by 3GPP network interfaces. SCEF internal architecture and APIs to expose these 3GPP service capabilities have, however, not been in scope of 3GPP, and SA2 has invited other organizations such as GSMA, OMA and oneM2M to consider the creation of useful set of APIs and the Exposure Function(s) such as the SCEF, to take advantage of the new capabilities enabled for the 3GPP networks.

Correspondingly oneM2M created a work item that has objective to specify the interworking architecture options between oneM2M architecture and 3GPP Release-13 architecture for Service Capability Exposure as defined in 3GPP TS 23.682. This inventions proposes the interworking architecture options for oneM2M platform for supporting the scenarios where the SCEF is hosted by the 3GPP Mobile Network Operator (MNO) vs. when it is hosted by M2M service provider or hosted by a 3rd party.

Techniques described in this documents can be used to overcome these problems, and others. As examples, embodiments in oneM2M and 3GPP network settings are discussed. The disclosed techniques, in one aspect, make service information available to devices using a standardized application programming interface (API), and establishing a framework by which service information is exposed to M2M devices, without the M2M devices having to spend valuable wakeup time to search for services in the network. In one advantageous aspect, in some embodiments, the framework communicates with the home subscriber server (HSS), which contains user-related and subscriber-related information, information about managing device mobility, user authentication, and so on.

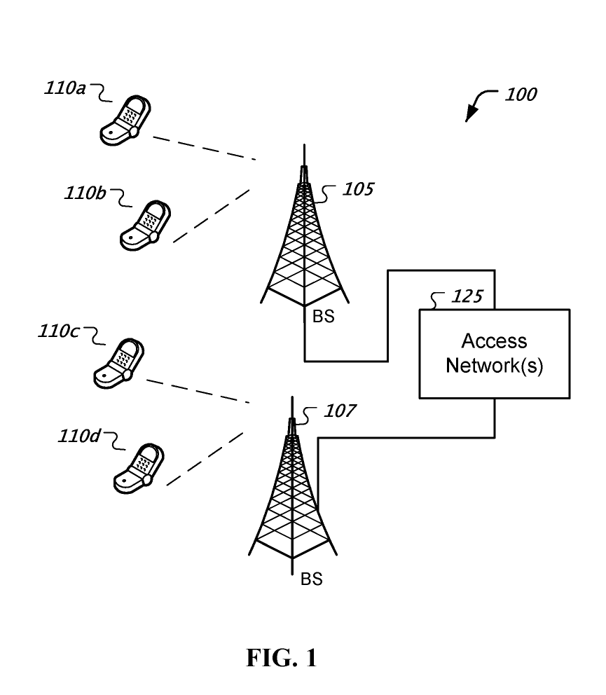

FIG. 1 shows an example of a wireless communication system, such as a TDD wireless communication system. System 100 can include a network of base stations (BSs) 105, 107 for communicating with one or more mobile devices 110a, 110b, 110c, 110d such as subscriber stations, mobile stations, user equipment, wireless air cards, mobile phones, and other wireless devices. In some implementations, a mobile device can have a fixed location, e.g., a desktop computer with a wireless air card. A core network 125 can include one or more controllers to control one or more base stations 105, 107. A controller can include processor electronics such as a processor(s) or specialized logic. A controller's functionality can be split into multiple components within a core network 125.

Mobile devices 110a, 110b, 110c, 110d can be a mobile unit or a fixed unit. A fixed unit can be located and/or relocated anywhere within the coverage area of system 100. Fixed unit wireless device can include, for example, desktop computers and computer servers. Mobile units can include, for example, mobile wireless phones, Personal Digital Assistants (PDAs), mobile devices, mobile computers.

A base station 105, 107 in system 1500 can include a radio transceiver. A base station 105, 107 can transmit signals to a mobile device 110a, 110b, 110c, 110d via downlink radio signals. A mobile device 110a, 110b, 110c, 110d in system 100 can include a radio transceiver. A mobile device 110a, 110b, 110c, 110d can transmit signals to a base station 105, 107 via uplink radio signals.

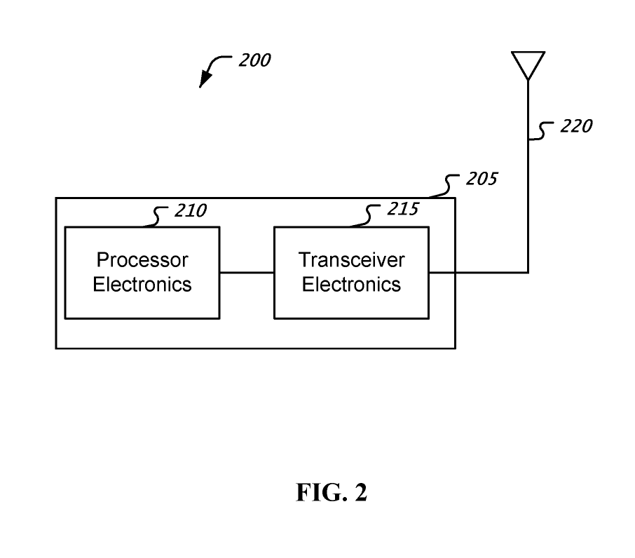

FIG. 2 shows an example of a radio station architecture. A radio station 200 such as a base station or a mobile device can include processor electronics 210. Processor electronics 210 can include a processing unit configured to perform one or more operations or techniques described herein. A processing unit can include one or more specialized or general propose processors and/or specialized logic. A radio station 205 can include transceiver electronics 215 to send and/or receive wireless signals over a communication interface such as antenna 220. Radio station 205 can include other communication interfaces for transmitting and receiving data. In some implementations, a processing unit can be configured to implement some or all of the functionality of a transceiver.

The techniques described in the present document may be implemented using a platform as described with respect to FIG. 2.

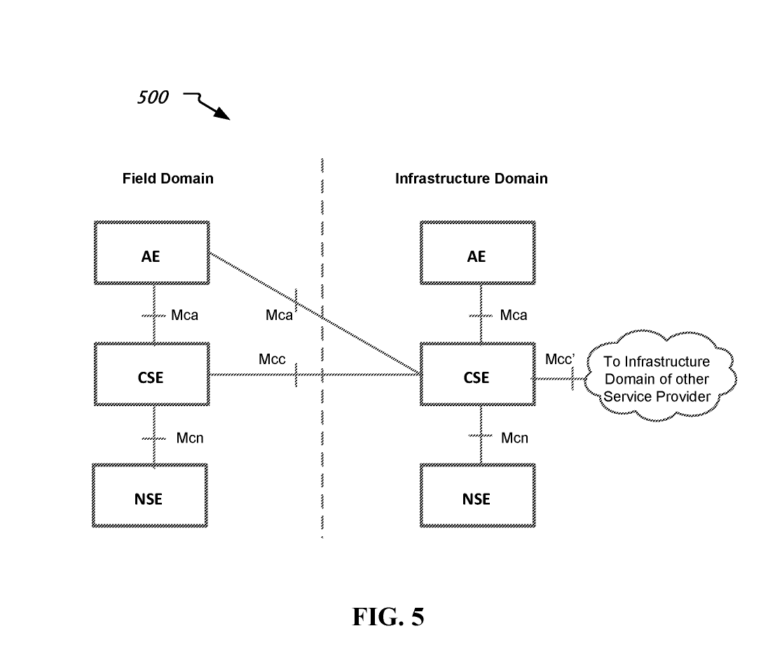

FIG. 5 shows an example of functional architecture 500 of an oneM2M system. In FIG. 5, the following abbreviations are used: AE—Application Entity; CSE—Common Services Entity; NSE—Network Services Entity. The connections Mca, Mcn, Mcc & Mcc′ represent reference points with a priori and well-defined communication protocols. The architecture 500 shows presently defined interfaces that devices are expected to implement and be able to communicate with other functional entities in the network.

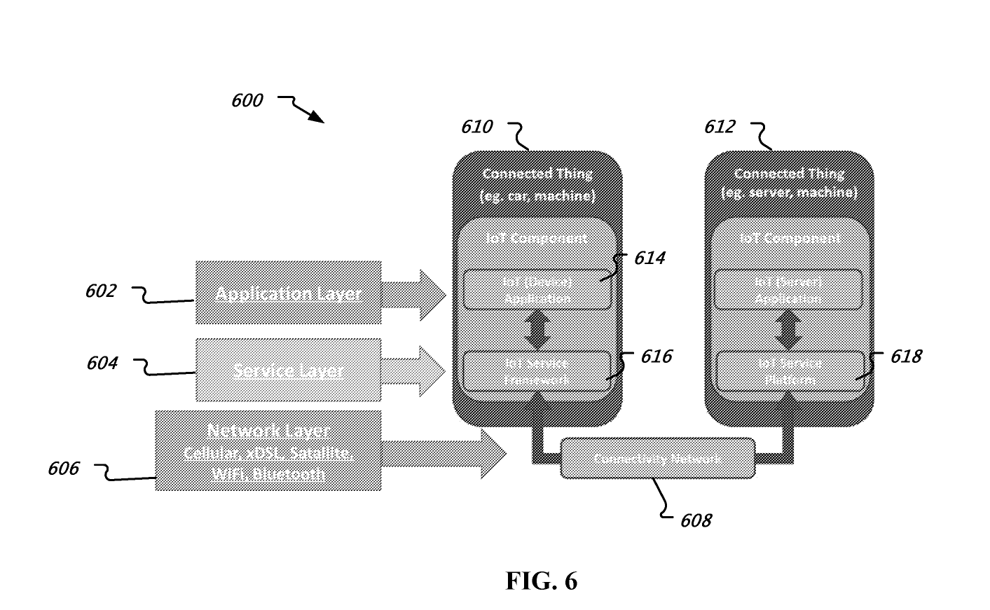

FIG. 6 shows an example of an M2M service delivery platform protocol stack 600. The oneM2M specifies a standard for M2M/IoT Common Service Layer. As depicted in FIG. 6, connected things such as machines 610 may communicate with other connected things such as servers that offer services 612 using a connectivity network 608. Each implementation 610, 612 may comprise an application layer 602, service layer 604 and a network layer 606 by which data is exchanged. The devices may further implement an Internet of things component that includes an application 614, and a framework 616 or service platform 618.

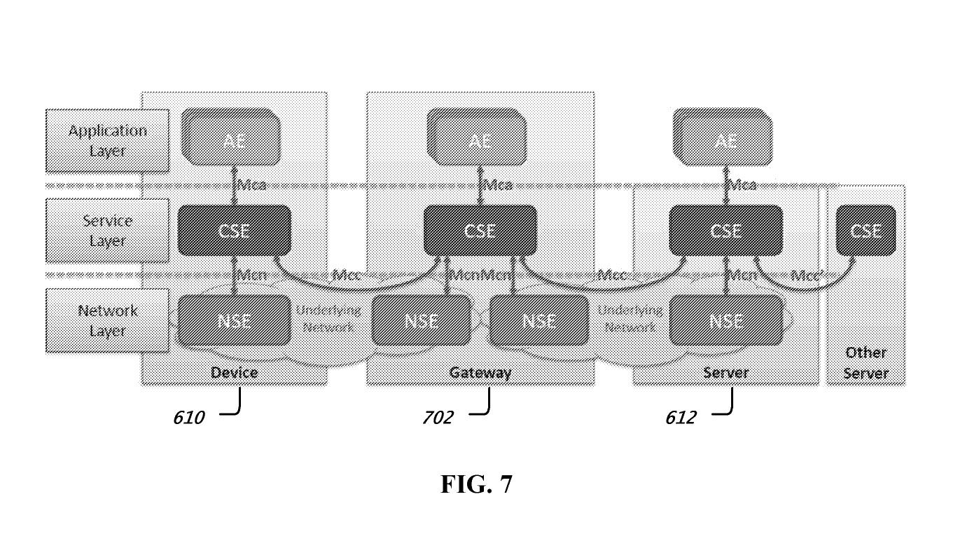

FIG. 7 shows an example M2M system configuration in which relationships between various application layer entities and the corresponding interfaces are shown. In a typical system, a device 610 may be able to communicate with a server with a possible gateway device 702 facilitating the communication. With reference to FIG. 6 and FIG. 7, oneM2M CSE in the infrastructure domain is referred to as oneM2M platform.

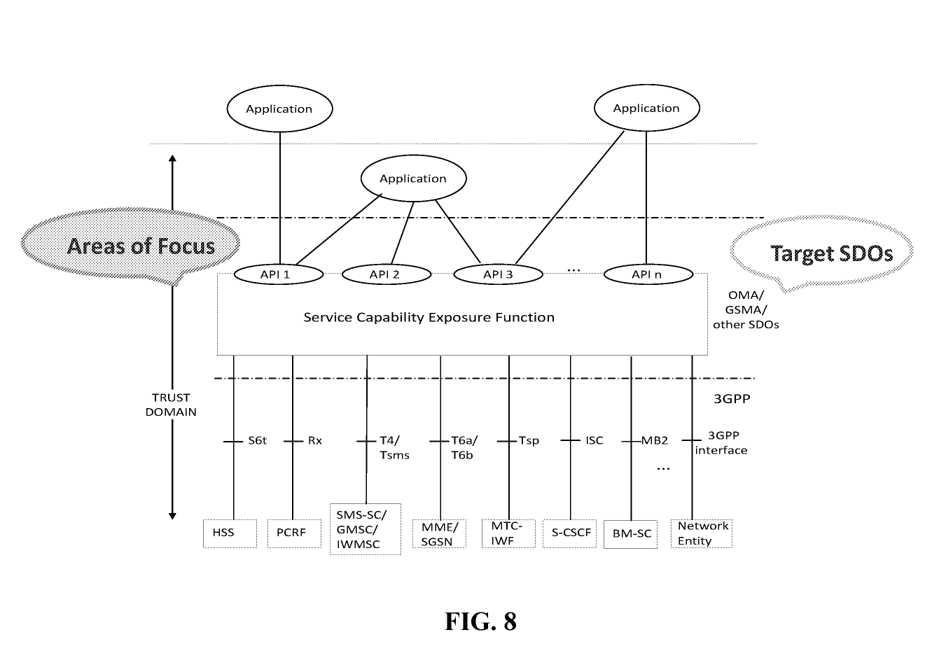

FIG. 8 shows an example of 3GPP architecture for service capability exposure. FIG. 8 also shows the possible positioning of the SCEF and APIs and interfaces by which the SCF could communicate with various applications (on the top) and various functional entities in a 3GPP network (used as an illustrative example).

In various embodiments, different deployment scenarios such as SCEF hosted by MNO, hosted by oneM2M Service Provider or hosted by a 3rd party service provider may be implemented.

For example, in some embodiments, an IN-CSE (oneM2M platform) provides SCEF functionality and interfaces directly with the 3GPP network. Such may be an implementation when SCEF is hosted by trusted oneM2M service provider

In some embodiments, the IN-CSE interfaces with the SCEF using OMA defined other APIs. Such embodiments may be suitable in cases when SCEF is hosted by MNO or by a trusted 3rd party service provider.

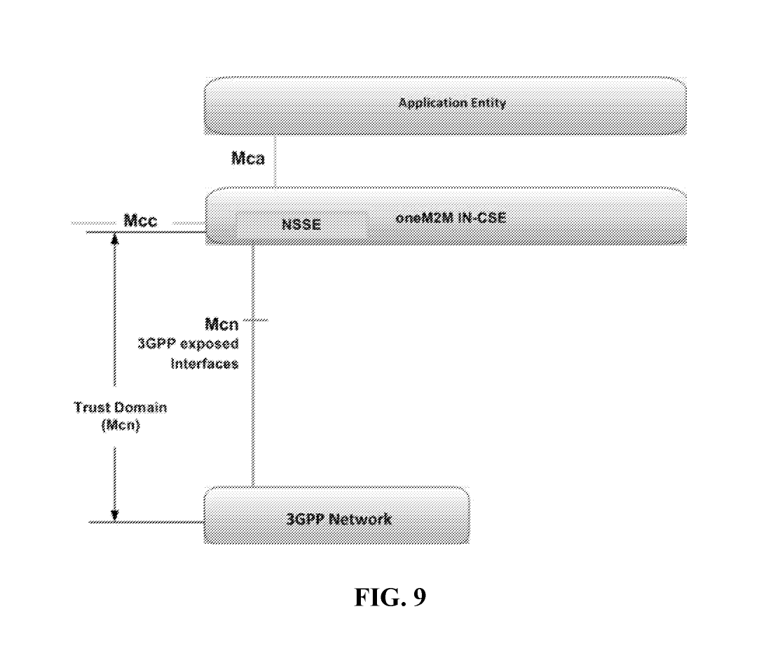

FIG. 9 shows an example embodiment in which a oneM2M platform hosts SCEF.

In some embodiments, a oneM2M service provider may be a trusted business partner of 3GPP MNO. Alternatively, 3GPP MNO can be the oneM2M service provider also. For example, NSSE in IN-CSE provides SCEF functionality and interfaces directly with the 3GPP network entities via 3GPP exposed interfaces. In such embodiments, the oneM2M platform is equivalent to SCEF in 3GPP architecture. In some embodiments, SCEF southbound exposed interfaces (e.g. S6*, Rx, T4 etc.) can be mapped to Mcn reference point.

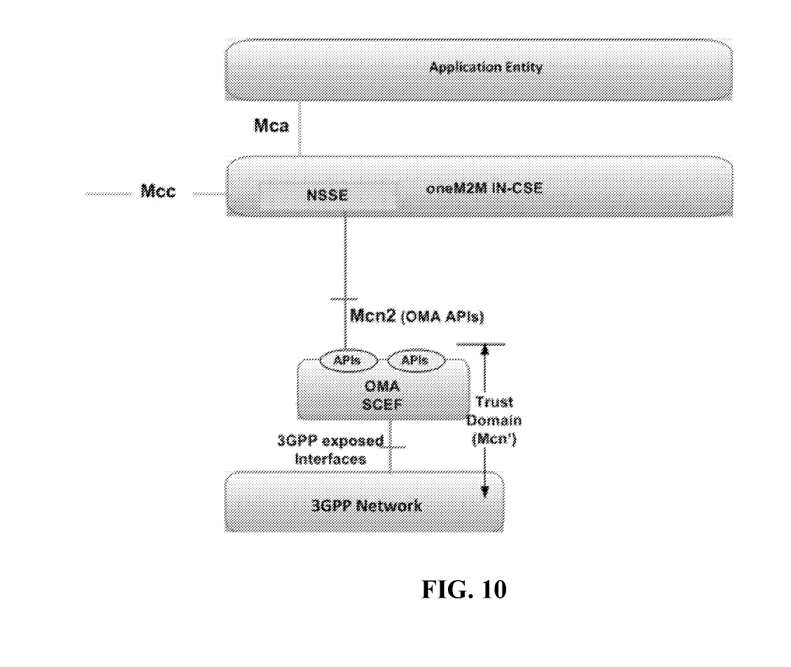

FIG. 10 shows an example embodiment in which SCEF is an independent functional entity. The depicted example of FIG. 10 supports standalone SCEF. In this case, SCEF is in 3GPP trust domain. This arrangement also allows 3GPP MNO to be SCEF provider as well In such embodiments, a oneM2M platform is equivalent to Service Capability Server (SCS) in 3GPP architecture. In some embodiments, SCEF northbound interface is the OMA specified APIs that are mapped to Mcn. In some embodiments, SCEF communicates with 3GPP network entities over 3GPP exposed interfaces (e.g. S6*, Rx, T4 etc.).

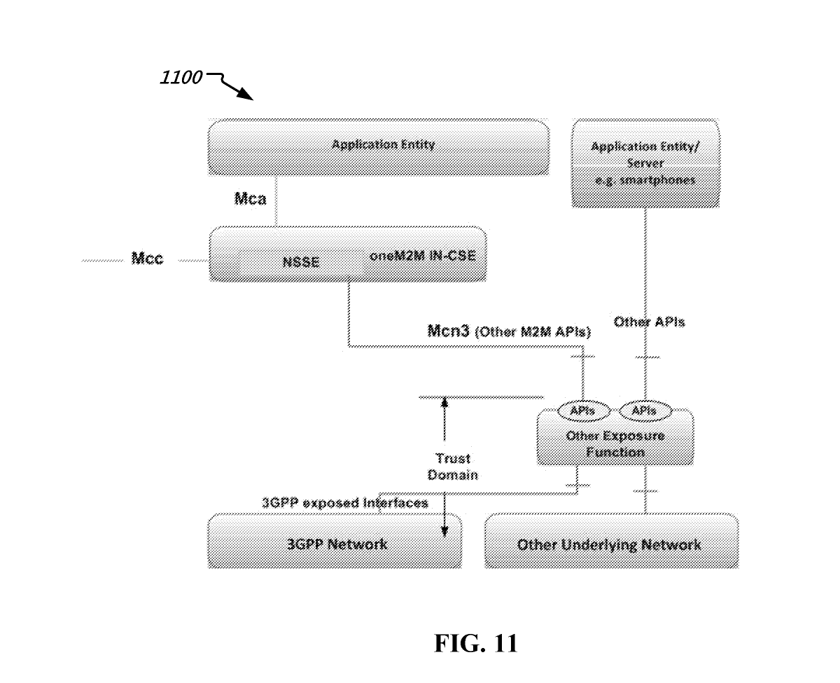

FIG. 11 shows an example embodiment architecture 1100 in which a oneM2M implementation supports other APIs. This embodiment may be considered to be an extension of oneM2M Interworking described with respect to FIG. 10. The embodiment architecture 1100 supports a standalone ‘Other Exposure Function’. This other ‘Exposure Function’ is in 3GPP network trust domain. By doing so, the architecture 1100 enables a 3GPP MNO to provide this ‘Other Exposure Function’ as well. In embodiments 1100, because oneM2M supported Other APIs, oneM2M platform is equivalent to SCS in 3GPP architecture. For Other APIs not supported by oneM2M, the Application Server (AS in 3GPP architecture) communicate with the ‘Other Exposure Function’ directly. In architecture 1100, ‘Other Exposure Function’ northbound interface is the Other APIs. The ‘Other Exposure Function’ communicates with 3GPP network entities over 3GPP exposed interfaces (e.g. S6*, Rx, T4 etc.).

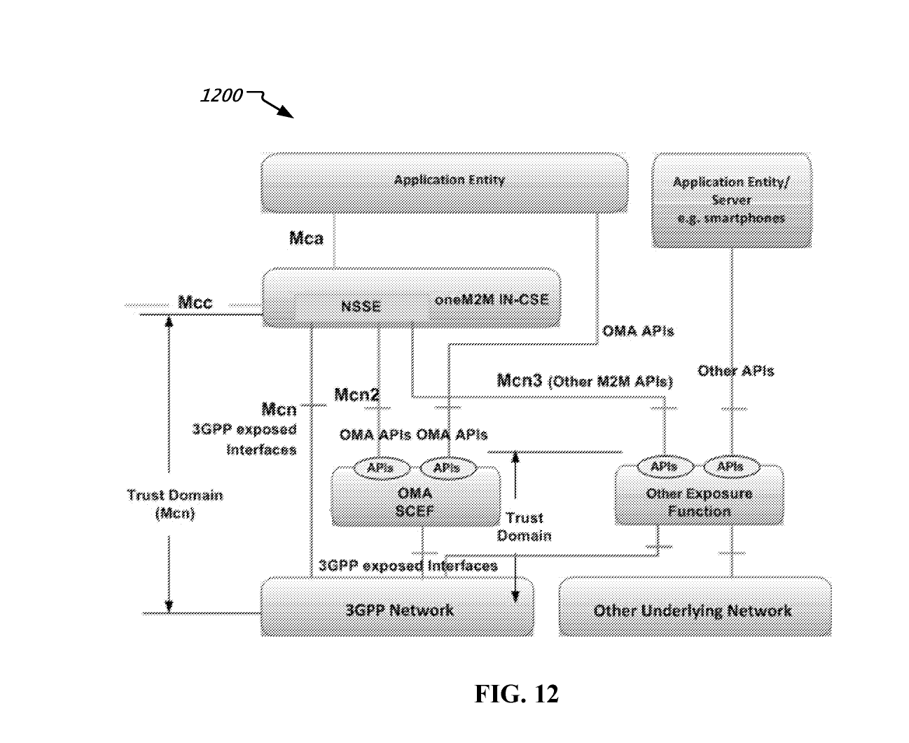

FIG. 12 is an example illustration of an interworking architecture 1200 in the context of oneM2M communication. The architecture 1200 may also be considered to be an extension of oneM2M Interworking described with respect to FIG. 10. Embodiments consistent with the architecture 1200 may supports a standalone ‘Other Exposure Function’. This other ‘Exposure Function’ is in 3GPP network trust domain, thereby allowing a 3GPP MNO to provide this ‘Other Exposure Function’ as well. For oneM2M supported Other APIs, oneM2M platform is equivalent to SCS in 3GPP architecture. For Other APIs not supported by oneM2M, the Application Server (AS in 3GPP architecture) communicate with the ‘Other Exposure Function’ directly. The ‘Other Exposure Function’ northbound interface is the Other APIs. The ‘Other Exposure Function’ communicates with 3GPP network entities over 3GPP exposed interfaces (e.g. S6*, Rx, T4 etc.).

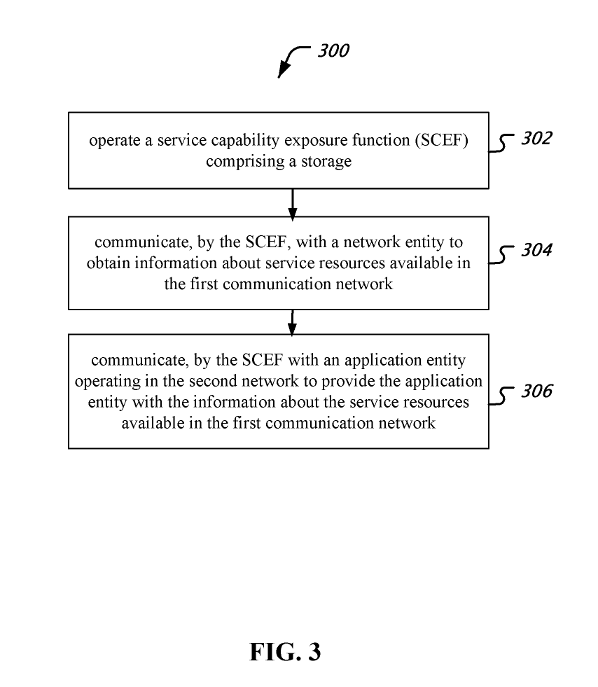

With reference to FIG. 3, an example flow chart for a method 300 for facilitating interoperation of a first application entity operating in a first communication network and a second application entity operating in a second communication network is disclosed. In Appendix B, e.g., several embodiments are disclosed in which the first communication network may be 3GPP or another wide area network and the second network may be a local area network or oneM2M network.

The method 300 includes operating (302), in a trusted domain of the first communication network and the second communication network, a service capability exposure function (SCEF) comprising a storage by which service capability information for at least some application entities in the first communication network and/or the second communication network is made accessible.

The method 300 includes communicating (304), by the SCEF, using a first pre-defined protocol via a first interface of the SCEF, with a network entity in the first communication network to obtain information about service resources available in the first communication network. In some embodiments, the SCEF updates the service capability information for the at least some application entities in the first communication network independent of queries from devices in the second communication network for the service capability information. Such embodiments may be advantageously used by M2M devices that frequently go through long sleep cycles such that, upon wake-up, a system's latest service information is available to a device by a simple query to the SCEF. In one advantageous aspect, as previously discussed, this arrangement could significantly reduce the latency of service availability upon wake-up.

The method 300 includes communicating (306), by the SCEF, using a second pre-defined protocol via a second interface of the SCEF, with an application entity operating in the second network to provide the application entity with the information about the service resources available in the first communication network.

The method 300 may be used to provide different resource information to different applications. For example, the method 300 may provide storage information to one application while provide display capability or bandwidth capability information to another application. Which services are exposed to which user device may be controlled by a masking parameter which may be settable by a network operator's business policy.

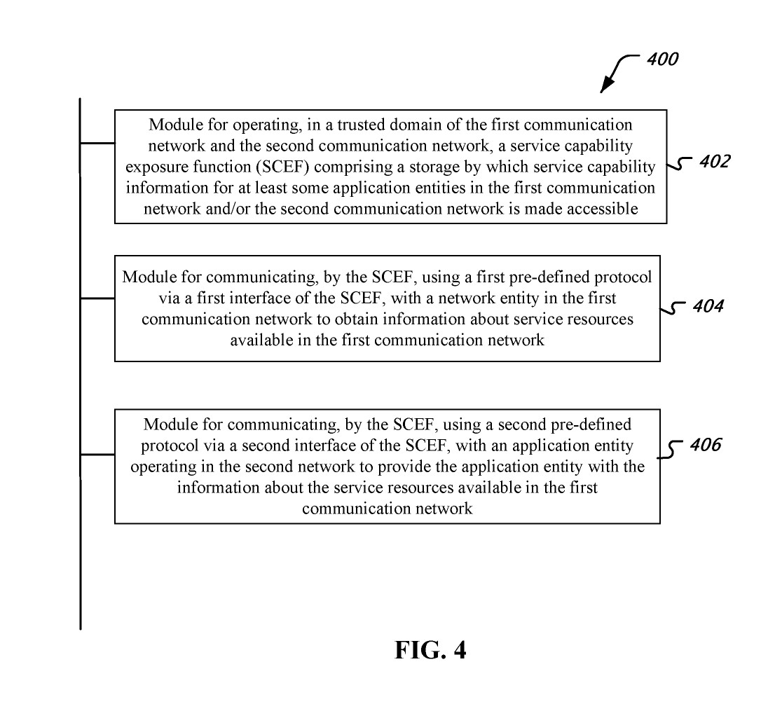

FIG. 4 shows a block diagram of an example apparatus 400 for facilitating interoperation of a first application entity operating in a first communication network and a second application entity operating in a second communication network. The apparatus includes a module 402 for operating, in a trusted domain of the first communication network and the second communication network, a service capability exposure function (SCEF) comprising a storage by which service capability information for at least some application entities in the first communication network and/or the second communication network is made accessible, a module 404 for communicating, by the SCEF, using a first pre-defined protocol via a first interface of the SCEF, with a network entity in the first communication network to obtain information about service resources available in the first communication network, and a module 406 for communicating, by the SCEF, using a second pre-defined protocol via a second interface of the SCEF, with an application entity operating in the second network to provide the application entity with the information about the service resources available in the first communication network.

In some embodiments, an apparatus may be used to implement the SCEF. The apparatus may include a memory, a processor, a first network interface and a second network interface. The processor may read instructions from the memory and implements a method for facilitating interoperation of a first application entity operating in a first communication network and a second application entity operating in a second communication network. The instructions may include instructions for operating, in a trusted domain of the first communication network and the second communication network, a service capability exposure function (SCEF) comprising a storage by which service capability information for at least some application entities in the first communication network and/or the second communication network is made accessible, instructions for communicating, by the SCEF, using a first pre-defined protocol via the first network interface of the SCEF, with a network entity in the first communication network to obtain information about service resources available in the first communication network, and instructions for communicating, by the SCEF, using a second pre-defined protocol via the second network interface of the SCEF, with an application entity operating in the second network to provide the application entity with the information about the service resources available in the first communication network.

The disclosed and other embodiments and the functional operations and modules described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

1. A method for facilitating interoperation of a first application entity operating in a first communication network and a second application entity operating in a second communication network, the method comprising:
operating, in a trusted domain of the first communication network and the second communication network, a service capability exposure function (SCEF) comprising a storage by which service capability information for at least some application entities in the first communication network and/or the second communication network is made accessible;
communicating, by the SCEF, using a first pre-defined protocol via a first interface of the SCEF, with a network entity in the first communication network, to obtain information about service resources available in the first communication network;
communicating, by the SCEF, using a second pre-defined protocol via a second interface of the SCEF, with an application entity operating in the second network to provide the application entity with the information about the service resources available in the first communication network.

2. The method of claim 1, wherein the first interface is interfacing with a wide area network and the second interface is interfacing with a local area network.

3. The method of claim 2, wherein the wide area network is a third generation partnership project 3GPP network.

4. The method of claim 1, wherein the information about resources available in the communication network is different for different applications.

5. The method of claim 1, wherein the information about services available in the first communication network is controlled by business rules in the first communication network.

6. The method of claim 1, wherein the first application entity comprises a service provider's application server and wherein the second application entity comprises a mobile application on a user device.

7. The method of claim 1, wherein the SCEF updates the service capability information for the at least some application entities in the first communication network independent of queries from devices in the second communication network for the service capability information.

8. An apparatus, comprising:
a memory;
a processor;
a first network interface; and
a second network interface;
wherein the processor reads instructions from the memory and implements a method for facilitating interoperation of a first application entity operating in a first communication network and a second application entity operating in a second communication network, the instructions comprising:
instructions for operating, in a trusted domain of the first communication network and the second communication network, a service capability exposure function (SCEF) comprising a storage by which service capability information for at least some application entities in the first communication network and/or the second communication network is made accessible;
instructions for communicating, by the SCEF, using a first pre-defined protocol via the first network interface of the SCEF, with a network entity in the first communication network to obtain information about service resources available in the first communication network; and
instructions for communicating, by the SCEF, using a second pre-defined protocol via the second network interface of the SCEF, with an application entity operating in the second network to provide the application entity with the information about the service resources available in the first communication network.

9. The apparatus of claim 8, wherein the first network interface is interfacing with a wide area network and the second interface is interfacing with a local area network.

10. The apparatus of claim 9, wherein the wide area network is a third generation partnership project 3GPP network.

11. The apparatus of claim 9, wherein the information about resources available in the communication network is different for different applications.

12. The apparatus of claim 9, wherein the information about services available in the first communication network is controlled by business rules in the first communication network.

13. The apparatus of claim 8, wherein the first application entity comprises a service provider's application server and wherein the second application entity comprises a mobile application on a user device.

14. The apparatus of claim 8, wherein the SCEF updates the service capability information for the at least some application entities in the first communication network independent of queries from devices in the second communication network for the service capability information.

15. A computer program product having code stored thereon, the code, when executed by a processor, causing the processor to implement a method, comprising:
operating, in a trusted domain of a first communication network and a second communication network, a service capability exposure function (SCEF) comprising a storage by which service capability information for at least some application entities in the first communication network and/or the second communication network is made accessible;
communicating, by the SCEF, using a first pre-defined protocol via a first interface of the SCEF, with a network entity in the first communication network, to obtain information about service resources available in the first communication network;
communicating, by the SCEF, using a second pre-defined protocol via a second interface of the SCEF, with an application entity operating in the second network to provide the application entity with the information about the service resources available in the first communication network.

16. The computer program product of claim 15, wherein the first interface is interfacing with a wide area network and the second interface is interfacing with a local area network.

17. The computer program product of claim 15, wherein the information about resources available in the communication network is different for different applications.

18. The computer program product of claim 15, wherein the information about services available in the first communication network is controlled by business rules in the first communication network.

19. The computer program product of claim 15, wherein the first application entity comprises a service provider's application server and wherein the second application entity comprises a mobile application on a user device.

20. The computer program product of claim 15, wherein the SCEF updates the service capability information for the at least some application entities in the first communication network independent of queries from devices in the second communication network for the service capability information.
